(19) United States
(12) Patent Application Publication
(10) Pub. No.: US 2006/0237972 A1
(43) Pub. Date: Oct. 26, 2006

(54) Hollow generator

(76) Inventor: William Sheridan Fielder, Ojai, CA (US)

Correspondence Address: WILLIAM S. FIELDER, P.O. BOX 1221, OJAI, CA, 93024-1221, US

(21) Appl. No.: 11/410,387

(22) Filed: Apr. 24, 2006

Related U.S. Application Data
(60) Provisional application No. 60/674,952, filed on Apr. 25, 2005.

(51) Int. Cl. F01D 15/10; H02K 5/12; H02K 51/00

(52) U.S. Cl. 290/52; 310/86; 310/232; 310/102 R

(57) ABSTRACT

Lacking a physical axis of rotation, this all-in-one electric generator/turbine requires less kinetic energy, substantially fewer parts, and less space in the power plant than do traditional designs. This is achieved by attaching the generator's magnets directly to the outer surface of the Hollow Turbine's rotating cylinder. Rotating magnetic fields generate current in adjacent stationary coils of an electric conductor. The design eliminates the need for a separate rotor and related shaft, as found in standard electric generator designs.

### CROSS-REFERENCE TO RELATED APPLICATIONS:

This application is related to application Ser. No. 10/885,876, filed Jul. 6, 2004, by the present inventor. Everything included in this application Ser. No. 10/885,876, Hollow Turbine, is incorporated by reference in the present application.

This application claims the benefit of provisional patent application Appl. No. 60/674,952, filed Apr. 25, 2005 by the present inventor.

### FEDERALLY SPONSORED RESEARCH

None.

### SEQUENCE LISTING

None.

### BACKGROUND OF INVENTION

1. Field of Invention

This invention generally relates to electric generators, specifically to hydroelectric generators and power plants.

2. Prior Art

Typical installations separate the turbine from the rotor carrying the generator's magnets with an extended shaft. This introduces additional weight that reduces efficiency and requires significantly more space in the power house. The referenced Hollow Turbine captures kinetic energy and transfers that energy by means of gears and pulleys; these also introduce complexity and friction.

3. OBCECTS AND ADVANTAGES

Accordingly, several objects and advantages of the invention are: increased efficiency, fewer moving parts, reduced space requirements, and less maintenance, while vastly increasing the number of sites capable of harnessing hydroelectric power.

This invention substitutes the gears or pulleys utilized by the Hollow Turbine, to transfer rotational energy, with a plurality of magnets attached to the outer surface of the turbine's cylinder. Immediately adjacent to these rotating magnets are stationary coils of an electric conductor, known as stators.

Further objects and advantages will become apparent from a consideration of the ensuing description and drawings.

### SUMMARY

This invention transforms a Hollow Turbine into an all-in-one generator/turbine. The invention substitutes coils and magnets in place of the rotary connecting elements, i.e., gears, as depicted in the prior art. Magnets are affixed to the outer surface of the Hollow Turbine's cylinder in place of the gear. The generator's stationary coil(s) of the electric conductor, a.k.a. stator(s), is/are positioned around the turbine's magnets. The rotating cylinder with attached magnets causes the magnetic field around the coils of electric conductors to change, inducing a current in the conductors.

Buoyancy Belts as depicted in Buoyant Generator (application Ser. No. 11/364,616), if incorporated, offset the effects of gravity, namely friction, and result in a highly efficient generator. A Directional Funnel as depicted in the Hollow Turbine patent application increases the efficiency of the turbine in applications with low head, such as ocean energy systems. An Energy Storage Spring, as specified in the Self-Winding Generator (application Ser. No. 11/062,215) removes inconstant rotational energy when present.

### DRAWINGS—FIGURES

FIG. 1 PRIOR ART: Hollow Turbine.

FIG. 2 is a Hollow Turbine with attached electromagnets and slip rings on both sides of the attached electromagnets. Also shown are stationary coils of an electric conductor.

FIG. 3 is a Hollow Turbine with attached electromagnets and slip rings on one side of the attached electromagnets. Also shown are stationary coils of an electric conductor.

FIG. 4 is a Hollow Turbine with attached permanent magnets and stationary coils of an electric conductor, a.k.a. Brushless A.C. Generator.

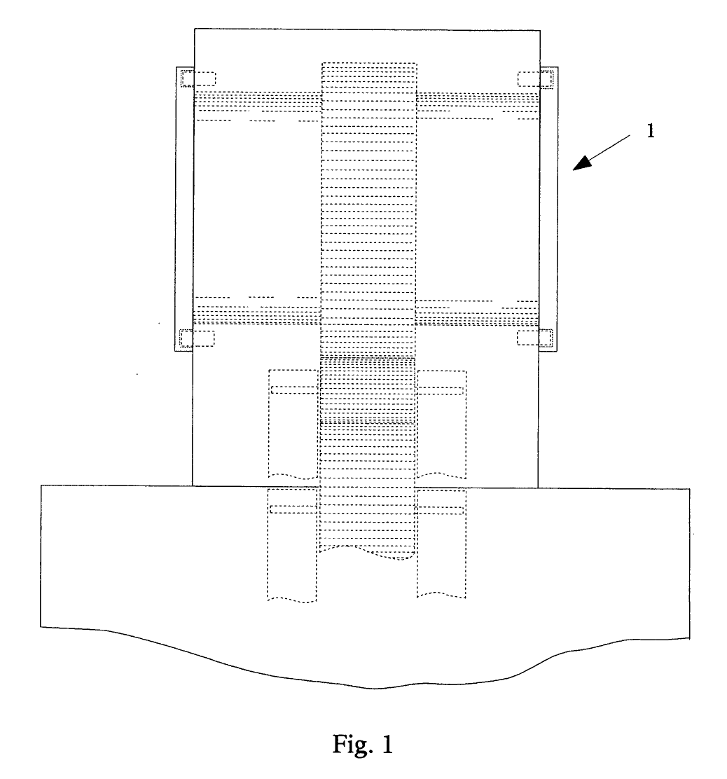

### DRAWINGS—REFERENCE NUMERALS

1 Hollow Turbine
2 Outer surface of cylindrical shell (a.k.a. rotor)
3 Electromagnet
4 Exciter
5 Electric conductor
6 Permanent magnet
7 Coil of an electric conductor (a.k.a. stator)
8 Slip ring
9 Brush—stationary contact
10 Axis of rotation
11 Brushless A.C. Generator

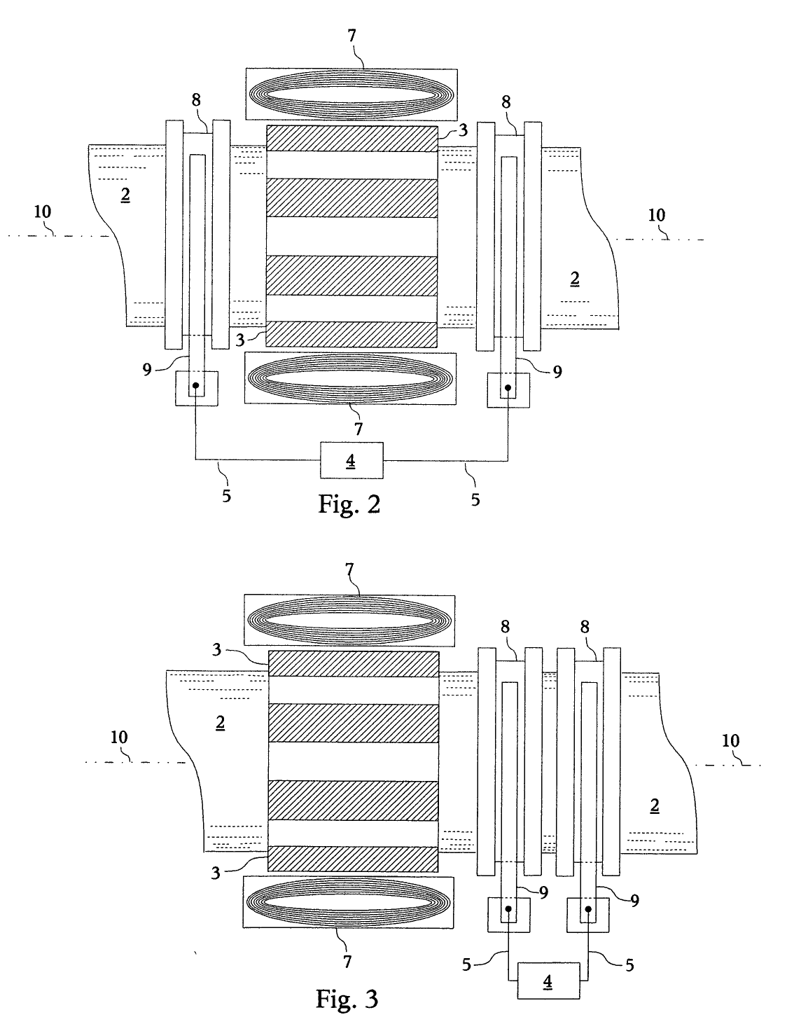

### DETAILED DESCRIPTION—PREFERRED EMBODIMENT—FIG. 2

Electromagnets 3 are attached by bolts and nuts or clamps to the outer surface 2 of a Hollow Turbine 1. Also attached, by bolts and nuts or clamps to the Hollow Turbine's outer surface 2, are two slip rings 8, at both sides of the attached electromagnets 3. Electromagnets 3 and slip rings 8 are electrically connected (not shown). Brushes 9 are aligned to come into electrical contact with the slip rings 8 and conduct electric current from an external source, such as an exciter 4, by electric conductor 5.

Stationary coils of an electric conductor 7 are positioned as close as possible to the electromagnets 3, and mounted around the outer surface 2 of the Hollow Turbine′ cylinder 2. Stationary coils of an electric conductor 7 connect to transformers and distribution equipment (not shown).

### Operation—Preferred Embodiment—FIG. 2

The Hollow Turbine 1 captures kinetic energy from passing fluids or gasses and transforms it into rotational energy. As the turbine rotates, so do the attached electromagnets 3 that are energized by an external power source, such as an exciter 4. The rotating electromagnets 3 within the stationary coils of an electric conductor 7 generate an electric current that is transferred to transformers and distribution equipment (not shown).

### Detailed Description—Alternative Embodiment—FIG. 3

Electromagnets 3 are attached by bolts and nuts or clamps to the outer surface 2 of a Hollow Turbine 1. Also attached, by bolts and nuts or clamps, to the Hollow Turbine's outer surface 2, are two slip rings 8 at one side of the attached electromagnets 3. Electromagnets 3 and slip rings 8 are electrically connected (not shown). Brushes 9 are aligned to come into electrical contact with the slip rings 8 and to conduct electric current from an external source, such as an exciter 4, by electric conductor 5.

Stationary coils of an electric conductor 7 are positioned as close as possible to electromagnets 3, and mounted around the outer surface 2 of Hollow Turbine 1. Stationary coils of an electric conductor 7 connect to transformers and distribution equipment (not shown).

### Operation—Alternative Embodiment—FIG. 3

The Hollow Turbine 1 captures kinetic energy from passing fluids or gasses and transforms it into rotational energy. As the turbine rotates, so do the attached electromagnets 3 that are energized by an external power source, such as an exciter 4. The rotating electromagnets 3 within the stationary coils of an electric conductor 7 generate an electric current that is transferred to transformers and distribution equipment (not shown).

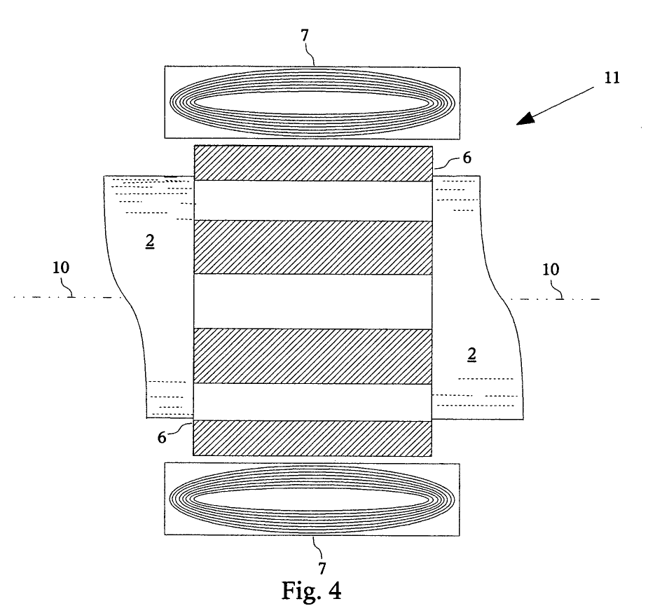

### Detailed Description—Alternative Embodiment—FIG. 4

Permanent magnets 6 are attached by bolts and nuts or clamps to the outer surface 2 of a Hollow Turbine 1.

Stationary coils of an electric conductor 7 are positioned as close as possible to permanent magnets 6, mounted around the outer surface 2 of Hollow Turbine 1. Stationary coils of an electric conductor 7 connect to transformers and distribution equipment (not shown).

### Operation—Alternative Embodiment—FIG. 4

The Hollow Turbine I captures kinetic energy from passing fluids or gasses and transforms it into rotational energy. As the turbine rotates, so do the attached permanent magnets 6. The rotating permanent magnets 6 within the stationary coils of an electric conductor 7 generate an electric current that is transferred to transformers and distribution equipment (not shown).

### Conclusion, Ramifications, and Scope

Therefore, the reader will see that according to the invention, I have provided an all-in-one electric generator/turbine that requires less kinetic energy to operate than conventional designs. Lower energy requirements will allow hydropower plants to be constructed in areas previously deemed inadequate due to limited amounts of kinetic energy. Fewer moving parts means greater efficiencies, requires less space in the power plant, as well as less maintenance and fewer points of failure.

The invention is applicable to existing and traditional hydroelectric power plants, standalone dam free installations in open waterways, and offshore hydroelectric plants.

While the above description contains many specificities, these should not be construed as limitations on the scope of the invention, but as exemplifications of the presently preferred embodiments thereof. Other ramifications and variations are possible within the teachings of the invention. For example, pneumatic energy capture systems may also benefit from the invention.

Thus the scope of the invention should be determined by the appended claims and their legal equivalents, and not by the examples given.

1. An all-in-one electric generator/turbine comprising:
a Hollow Turbine;
at least one array of magnets mounted on the outer surface of said Hollow Turbine;
at least one stationary coil of an electric conductor;
a supporting structure;
whereby kinetic energy is captured and transformed into electricity efficiently in a compact fashion.

2. The at least one array of magnets as claimed in claim #1, wherein said magnets are electromagnets.

3. The electromagnets as claimed in claim #2, further comprising two electrically connected slide rings.

4. The two slide rings as claimed in claim #3, further comprising two brushes, stationary contacts, connected to an electric power source.

5. The electric power source as claimed in claim #4, wherein said electric power source is an exciter.

6. The at least one array of magnets as claimed in claim #1, wherein said magnets are permanent magnets.

7. The supporting structure as claimed in claim #1, further comprising a means of allowing said Hollow Turbine to rotate freely inside the said at least one stationary coil of an electric conductor, wherein said means are bearings.

8. A method of generating electricity comprising:
providing a Hollow Turbine;
attaching at least one array of magnets mounted on the outer surface of said Hollow Turbine;
positioning at least one stationary coil of an electric conductor around the said at least one array of magnets;
providing a supporting structure enabling said Hollow Turbine to rotate freely inside the said at least one stationary coil of an electric conductor;
whereby kinetic energy is captured and transformed into electricity efficiently in a compact fashion.

9. An all-in-one electric generator/turbine comprising:
a cylindrical shell having an inner and an outer surface, and holes of the same size at each of the opposing ends of said cylindrical shell;
at least one plurality of blades attached to said inner surface of said cylindrical shell;
at least one array of magnets mounted on the said outer surface of said cylindrical shell;
at least one stationary coil of an electric conductor;
a supporting structure;
whereby kinetic energy is captured and transformed into electricity efficiently in a compact fashion.

10. The at least one array of magnets as claimed in claim #9, wherein said magnets are electromagnets.

11. The electromagnets as claimed in claim #10, further comprising two electrically connected slide rings.

12. The two slide rings as claimed in claim #11, further comprising two brushes, stationary contacts, connected to an electric power source.

13. The electric power source as claimed in claim #12, wherein said electric power source is an exciter.

14. The at least one array of magnets as claimed in claim #9, wherein said magnets are permanent magnets.

15. The supporting structure as claimed in claim #9, further comprising a means of allowing said cylindrical shell to rotate freely inside the said at least one stationary coil of an electric conductor, wherein said means are bearings.

16. The cylindrical shell as claimed in claim #9, wherein said cylindrical shell is made from composite materials.

17. The inner surface of the cylindrical shell as claimed in claim #9, further comprising a titanium veneer.

18. The plurality of blades as claimed in claim #9, wherein said plurality of blades are made from composite materials.

19. The plurality of blades as claimed in claim #9, further comprising a titanium veneer.

20. A method of generating electricity comprising:
providing a cylindrical shell having an inner and an outer surface, and holes of the same size at each of the opposing ends of said cylindrical shell;
attaching at least one plurality of blades to said inner surface of said cylindrical shell;
attaching at least one array of magnets mounted on the said outer surface of said cylindrical shell;
positioning at least one stationary coil of an electric conductor around said at least one array of magnets;
providing a supporting structure enabling said cylindrical shell to rotate freely inside the said at least one stationary coil of an electric conductor;
whereby kinetic energy is captured and transformed into electricity efficiently in a compact fashion.
